(19) United States
(12) Patent Application Publication
(10) Pub. No.: US 2015/0095276 A1
(43) Pub. Date: Apr. 2, 2015

(54) DEMAND FLEXIBILITY ESTIMATION

(71) Applicant: FUJITSU LIMITED, Kawasaki-shi (JP)

(72) Inventor: Jorjeta G. JETCHEVA, San Jose, CA (US)

(73) Assignee: FUJITSU LIMITED, Kawasaki-shi (JP)

(21) Appl. No.: 14/042,388

(22) Filed: Sep. 30, 2013

(51) Int. Cl. G06N 7/00

(52) U.S. Cl. CPC G06N 7/00
USPC 706/52; 706/54

(57) ABSTRACT

An example embodiment includes a method of estimating demand flexibility of a site. The method may include quantifying energy usage parameters of the site and determining coefficients. Each of the coefficients may include a value based on one of the energy usage parameters. The method may also include multiplying each of the coefficients by a weighting factor associated with each of the coefficients. The method may also include summing products of the coefficients and the associated weighting factors. The method may further include estimating a demand flexibility of the site for a DR event involving energy usage curtailment. The demand flexibility may be based at least partially on the summation of the products of the coefficients and the associated weighting factors.

### FIELD

The embodiments discussed herein are related to demand flexibility estimation.

### BACKGROUND

Utility companies incentivize curtailment of energy usage during certain high load periods to increase the ability of the utility company to meet a larger demand or to minimize production costs. For example, in summer months, peak energy usage may occur on hot days in the late afternoon. A utility company may offer an incentive to a factory to reduce energy usage during the late afternoon. In response, the factory may delay a high load production run until later in the evening, turn down the air conditioning in the factory, or otherwise reduce energy use. In this manner, the utility company may increase its ability to meet energy demands during the peak energy usage and/or avoid producing or purchasing additional energy to meet the energy demands.

The curtailment in energy usage during peak or high load periods may be referred to as demand response (DR). The energy usage curtailment during a specified time period may be referred to as a DR event. DR events generally occur when a utility company expects a high demand and asks customers to reduce or curtail energy usage. When a customer reduces its energy usage by an agreed upon amount, the utility company may provide an incentive to the customer.

In some DR systems, DR aggregators mediate communication between utility companies and customers. The DR aggregators generally have an agreement with the utility companies to coordinate with the customers and implement a DR event. Specifically, the DR aggregators identify customers that may participate in a DR event. The DR aggregators then notify the customer, assess whether the customer has complied with the energy curtailment of the DR event, and distribute incentives accordingly.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of estimating demand flexibility of a site may include quantifying energy usage parameters of the site. The method may also include determining coefficients. Each of the coefficients may include a value based on one of the energy usage parameters. The method may also include multiplying each of the coefficients by a weighting factor associated with each of the coefficients and summing products of the coefficients and the associated weighting factors. The method may further include estimating a demand flexibility of the site for a DR event involving energy usage curtailment. The demand flexibility may be based at least partially on the summation of the products of the coefficients and the associated weighting factors.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example demand response (DR) system;

FIG. 2 is a block diagram of the DR system of FIG. 1 including some example details that may be included in demand flexibility estimation;

FIG. 3 illustrates a block diagram of an example system that may be implemented in the DR systems of FIGS. 1 and 2; and

FIG. 4 a flow diagram of an example method of estimating demand flexibility of a site.

### DESCRIPTION OF EMBODIMENTS

Demand response (DR) may include coordinated resource usage curtailment by one or more sites to which a resource, such as energy, is distributed during high load periods. The resource usage curtailment during a specified time period may be referred to as a DR event. Coordination of DR events among participating sites, establishing DR systems, soliciting DR customers, and deciding whether to participate in a DR event may benefit from analytically estimating demand flexibility of the sites. The demand flexibility may include whether, and to what extent, the sites may curtail resource usage during a specified time period.

In current DR systems, DR aggregators, utilities, and site managers may rely on intuition to estimate demand flexibility. The lack of analytically estimating demand flexibility may result in inefficiencies. For example, a DR aggregator may expend time convincing a site to participate in a DR event when the site may not have sufficient demand flexibility to comply with resources usage curtailment included in a DR event. Likewise, the site manager may erroneously decide to participate in a DR event based on whether the site manager feels the site will be able to curtail sufficient amounts of resource usage to comply with the requirements of the DR event. Failure to comply with the DR event may result in a penalty or an unprofitable loss of production.

Accordingly, some embodiments disclosed herein relate to analytically estimating demand flexibility. The demand flexibility may be estimated based on one or more resource usage parameters (hereinafter, “parameters”). The parameters may be quantified from load data and/or ambient condition data. Coefficients based on one or more of the parameters may be weighted. The demand flexibility may be estimated based at least partially on a summation of the coefficients multiplied by weighting factors associated with each of the coefficients. The estimated demand flexibility may be further based on a productivity metric calculated for the site, DR event information, previous participation of one or more of the sites, or some combination thereof.

From the estimated demand flexibility, a site may determine whether or not it may comply with resource usage curtailment included in a DR event. For example, a site manager may estimate a demand flexibility that may indicate the site has sufficient demand flexibility to curtail an adequate amount of resource usage to comply with the DR event. Accordingly, the site manager may opt to participate in the DR event.

Additionally, from the estimated demand flexibility, a DR aggregator may estimate a participation likelihood for one or more sites. The DR aggregator may use participation likelihood to decide which of the sites to manage as DR customers. For example, the DR aggregator may ask sites with high demand flexibility to become DR customers because it may be more likely that sites with high demand flexibility will participate in DR events. Additionally, the DR aggregator may use the participation likelihood to determine which of its DR customers to solicit for an upcoming DR event. For instance, a site, which is a DR customer, may have previously had a high demand flexibility. However, for an upcoming DR event, the site may have a low demand flexibility. Accordingly, the DR aggregator may solicit another site to participate in the upcoming DR event. Furthermore, by analytically tracking the parameters and ultimate participation decisions of the sites, the DR aggregators may refine factors included in the estimation process. For example, the DR aggregator may determine an incentive amount that results in a specific site opting to participate in a DR event. Moreover, the estimated demand flexibility and/or the participation likelihood based thereon may enable the DR aggregator to generate a schedule of DR events including which sites are likely to participate. Example embodiments of the present invention will now be explained with reference to the accompanying drawings.

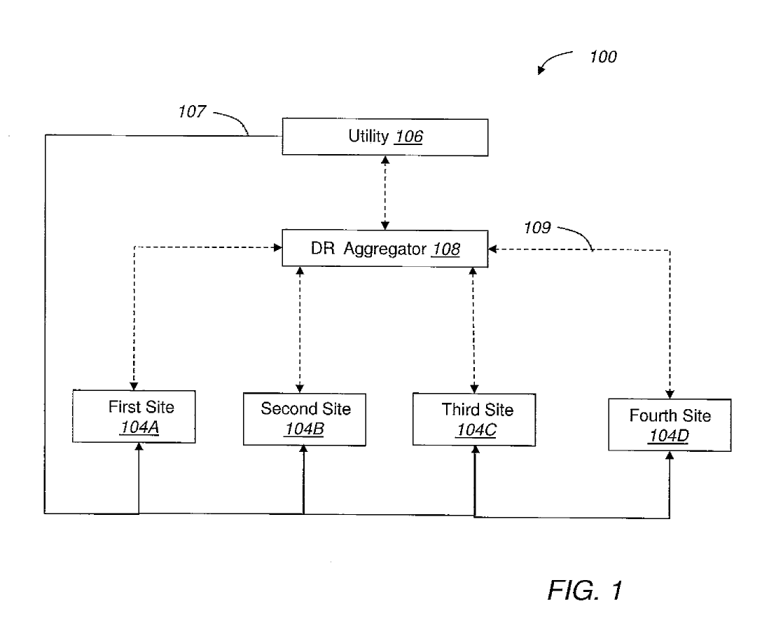

FIG. 1 is a block diagram of an example DR system 100, arranged in accordance with at least one embodiment described herein. The DR system 100 may be configured to enable estimation of a demand flexibility and/or a participation likelihood for one or more sites 104A-104D (generally, site 104 or sites 104) for a DR event. The demand flexibility may include whether, and to what extent, the sites 104 may curtail energy usage. By estimating the demand flexibility of the sites 104, a likelihood that the sites 104 will participate in and/or comply with a DR event may also be estimated. The demand flexibility and/or the participation likelihood may be used by the sites 104 to determine whether to participate in the DR event. Additionally or alternately, the demand flexibility and/or participation likelihood estimated in the DR system 100 may be used to identify one or more of the sites 104 to manage as DR customers or to include in the DR system 100. Furthermore, in some embodiments, the demand flexibility and/or the participation likelihood may be used to predict whether one or more of the sites 104 is likely to participate in the DR event.

The DR system 100 may include a utility 106, a DR aggregator 108, and the sites 104. In the DR system 100, the utility 106 may distribute a resource, such as electricity, gas, water or some other resource to the sites 104. The distribution of the resource to the sites 104 is represented in FIG. 1 by a line designated by item number 107. The DR system 100 is described herein with particularity in which the utility 106 provides the resource to the sites 104.

The DR system 100 may help to enable implementation of DR events. The DR events may include specified time periods during which one or more of the sites 104 curtail resource usage. Some DR events may include coordination of resource usage curtailment by multiple sites 104. A DR event may be scheduled during periods of high demand, for example. By curtailing resource usage during periods of high demand, the utility 106 may meet the high demand without purchasing or otherwise generating or locating additional resources. The utility 106 may offer an incentive to participate in the DR events.

The utility 106 may include any entity involved in production, transmission, and/or distribution of resources. The utility 106 may be publicly or privately owned. Some examples of the utility 106 may include a power plant, an energy cooperative, and an independent system operator (ISO). The utility 106 may be configured to identify a DR event and set terms for the DR event such as incentives, a time period, and overall resource usage curtailment.

In general, the sites 104 may be buildings, structures, equipment, or other objects that consume resources generated by the utility 106. The sites 104 may include multiple types of structures, etc., ranging from private residences to large industrial factories or office buildings. Within the sites 104 there may be one or more sites 104 that are related. For example, one or more subset of the sites 104 may be involved in a common economic pursuit, may have a similar size, may be located within a defined area, or may be related by another relevant characteristic. The utility 106 and/or the DR aggregator 108 may group the sites 104 according to one or more characteristics. Additionally, the utility 106 and/or the DR aggregator 108 may then acquire resource usage of the sites 104 and/or compare resource usage behaviors across one or more of the sites 104 or subsets thereof.

In these and other embodiments, the DR system 100 may include the DR aggregator 108. The DR aggregator 108 may act as an intermediary between the utility 106 and the sites 104 to coordinate implementation of one or more DR events. In particular, the DR aggregator 108 may coordinates DR events such that a cumulative resource usage curtailment of the sites 104 is sufficient to meet an overall resource usage curtailment of a DR event. In some embodiments, the incentive offered by the utility 106 may be received by the DR aggregator 108. The DR aggregator 108 may in turn offer some portion of the incentive to the sites 104 in exchange for participation in a DR event. The DR aggregator 108 may implement any DR incentive program including, but not limited to, a capacity bidding program (CBP) or a demand bidding program (DBP).

The sites 104 or some subset thereof may be managed by the DR aggregator 108. The DR aggregator 108 may specifically coordinate implementation of DR events by the sites 104 it manages. The DR aggregator 108 may accordingly be interested in identifying which of the sites 104 may have high demand flexibility and/or are likely to participate in an upcoming DR event.

The DR aggregator 108 may be communicatively coupled to the utility 106 and the sites 104. In FIG. 1, the communicative coupling between the DR aggregator 108, the utility 106, and the sites 104 is represented by dashed arrows. The dashed arrow between a fourth site 104D and the DR aggregator 108 is labeled with the item number 109. The utility 106, the DR aggregator 108, and the sites 104 may be communicative coupled via one or more wired or wireless networks. For instance, the networks may include the internet, mobile communication networks, one or more local area or wide area networks (LANs or WANs), any combination thereof, or any similar networking technology.

In the depicted embodiment, the DR aggregator 108 acts as an intermediary. However, inclusion of the DR aggregator 108 is not meant to be limiting. In some embodiments, the utility 106 may directly communicate with one or more of the sites 104. In these and other embodiments, the utility 106 may directly communicate with one or more sites 104 and the DR aggregator 108 may communicate with one or more other sites 104. For example, when one of the sites 104 uses substantial amounts of energy, the utility 106 may directly communicate with the site 104. In this example, the DR aggregator 108 may additionally communicate with other of the sites 104.

In the DR system 100, coordination of DR events, identifying the sites 104 to include in the DR system 100, and the sites 104 deciding whether to participate in DR events may include estimating demand flexibility of the sites 104. For example, the estimated demand flexibility of the sites 104 may enable a manager associated with the sites 104 to determine whether to participate in a DR event. Additionally or alternatively, the estimated demand flexibility may enable the utility 106 and/or the DR aggregator 108 to further estimate participation likelihood of the sites 104. The utility 106 and/or the DR aggregator 108 may predict participation of one or more of the sites 104 in an upcoming DR event based on the estimated participation likelihood and/or identify whether a site 104 is a potential DR customer that may be beneficially included in the DR system 100.

Modifications, additions, or omissions may be made to the DR system 100 without departing from the scope of the present disclosure. For example, while FIG. 1 depicts a first, a second, a third, and a fourth site 104A-104D, the present disclosure applies to a DR system architecture having one or more sites 104. Furthermore, while FIG. 1 includes one DR aggregator 108 and one utility 106, the DR system 100 may include multiple DR aggregators and/or multiple utilities. Additionally, in some embodiments, one or more of the sites 104 may be served by multiple DR aggregators and/or multiple utilities.

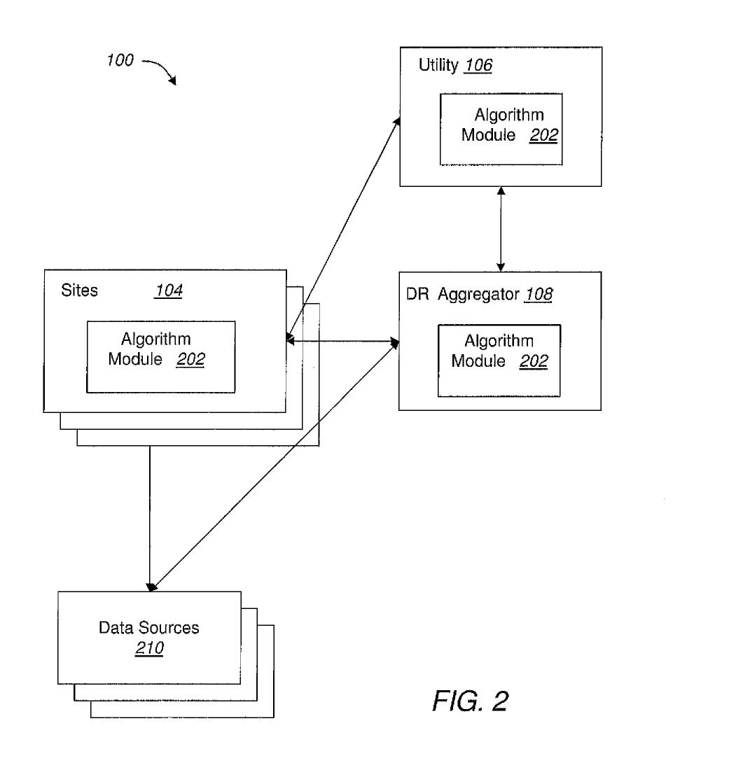

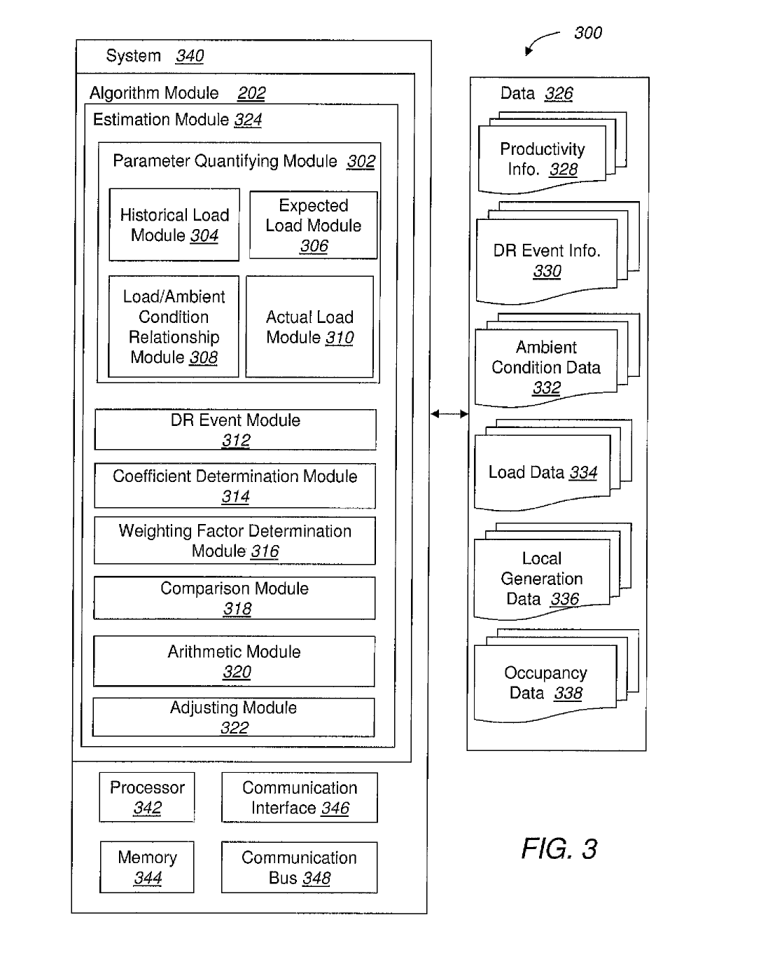

FIG. 2 is a block diagram of the DR system 100 of FIG. 1 including some example details that may be included in demand flexibility estimation, arranged in accordance with at least one embodiment described herein. The DR system 100 may include a demand flexibility algorithm module 202 (hereinafter and in FIGS. 2 and 3, “algorithm module 202”). Specifically, the algorithm module 202 may be included in one or more of the utility 106, the DR aggregator 108, and the sites 104 described with reference to FIG. 1. The algorithm module 202 may input data (not shown) regarding one of the sites 104 and/or information pertaining to an upcoming DR event. The algorithm module 202 may return an estimated demand flexibility and/or a likelihood that the site 104 will participate in the DR event.

The participation likelihood may be returned in the form of a percentage, for instance. For example, one of the sites 104 may operate at maximum occupancy during a DR event and while operating at maximum occupancy, the site 104 may use a predictable amount of a resource. Accordingly, the demand flexibility of the site 104 during the DR event may be low. Thus, it may be unlikely that the site 104 will participate in the DR event that involves curtailment of resource usage because the site 104 may be using the resource. In this circumstance, the algorithm module 202 may return 10%, for instance. On the other hand, if the site 104 is at a low occupancy during a DR event, then the demand flexibility of the site during the DR event may be high. Accordingly, it may be likely that the site 104 will participate in the DR event because the site 104 may not be using the resource. In this circumstance, the algorithm module may return 80%.

Each of the utility 106, the DR aggregator 108, and the sites 104 may use the algorithm module 202 to estimate participation likelihood and/or estimate demand flexibility of the sites 104 for a DR event. The sites 104 may use the estimated demand flexibility to determine whether or not to participate in a DR event. In these and other embodiments, the site 104 may estimate participation likelihood for itself. When the demand flexibility estimated in the algorithm module 202 is high for the site 104, the site 104 or manager thereof may decide to participate in the DR event. When the demand flexibility estimated in the algorithm module 202 is low for the site 104, the site 104 or the manager thereof may decide not to participate in the DR event. The algorithm module 202 may thus enable a site manager or another similar entity with information for making an informed decision regarding DR event participation for the site 104.

Additionally, the utility 106 and/or the DR aggregator 108 may use the estimated participation likelihood to identify sites 104 that may be managed as DR customers. For example, the sites 104 may include all or nearly all of the sites to which the utility 106 provides a resource. Some of the sites 104 may have consistently low demand flexibility and thus, may be poor candidates for DR customers due to the unlikeliness of their participation in DR events. In contrast, some of the sites 104 may have high demand flexibility. The sites 104 with high demand flexibility may make good candidates for DR customers due to the likeliness of their participation in DR events. The algorithm module 202 may provide the utility 106 and/or the DR aggregator 108 or another similar entity with information for identifying potential DR customers. After identifying potential DR customers, the utility 106 and/or the DR aggregator 108 may concentrate advertisements or solicitations on the identified potential DR customers. An example of a site 104 with consistently low demand flexibility may include a factory with a twenty-four-hour-a-day automated process with a relatively constant level of resource usage. The factory may not be able to curtail resource usage without stopping the process and may therefore not participate in DR events. In contrast, an example of a site 104 with high demand flexibility may include a factory having shift workers that may perform production runs at any time.

Additionally or alternatively, the utility 106 and/or the DR aggregator 108 may use the estimated participation likelihood to predict which of the sites 104 will participate in a DR event. The prediction may be made regarding a specific, upcoming DR event or a specific type of DR event, for instance. By predicting which of the sites 104 will participate in a DR event, the utility 106 and/or the DR aggregator 108 may properly allocate resources to solicit participation from the sites 104.

In some embodiments, the algorithm module 202 may also enable the predictions to include a margin of error. The margin of error may allow the DR aggregator 108 and/or the utility 106 to predict participation of the sites 104 while including a safety factor. Additionally, by predicting which of the sites 104 will participate in DR events, the utility 106 and/or the DR aggregator 108 may create a schedule of DR events. The schedule may include long-term forecasts of DR events and the sites 104 that will likely participate in the DR events, for instance.

In some embodiments, predicting whether one or more of the sites 104 will participate in a DR event may be based, at least partially, on estimated participation likelihood of other of the sites 104. Generally, when the prediction is based on the other sites 104, there may be some relationship between the other sites 104 and a site 104 for which participation likelihood is being estimated. The site 104 for which participation likelihood is being estimated may be referred to as “the site 104 of interest” for the discussion below.

As mentioned above, the utility 106 and/or the DR aggregator 108 may group one or more of the sites 104 based on a characteristic of the sites 104. In these and other embodiments, the utility 106 and/or the DR aggregator 108 may predict whether a site 104 of interest will participate in a DR event based on estimated participation likelihoods calculated for other of the sites 104 grouped with the site 104.

For example, the prediction may be described by an example prediction equation:

DRₛᵢₜₑ=q₁×DRₛᵢₜₑ_{_{—}}_{participation}+q₂×DR_{average}_{_{—}}_{group}_{_{—}}_{participation}

In the example prediction equation, the variable DRₛᵢₜₑ represents a refined participation likelihood estimated for a site 104 of interest. The refined participation likelihood may be a secondary estimate of participation likelihood based at least partially on estimated participation likelihoods of one or more of the other sites 104. The variable DRₛᵢₜₑ_{_{—}}_{participation} represents an estimated participation likelihood of the site 104 of interest calculated using the algorithm module 202. The variable DR_{average}_{_{—}}_{group}_{_{—}}_{participation} represents an average participation likelihood for the DR event for one or more other sites 104 that are grouped with the site 104. The average participation likelihood may be a mean of the estimated participation likelihoods calculated for the one or more of the other sites 104 using the algorithm module 202. The variable q₁ may represent a site participation weighting factor. The variable q₂ may represent a group participation weighting factor. According to the example prediction equation, the refined participation likelihood may be estimated for the site 104 of interest for a DR event based on the summation of the products of the group participation weighting factor multiplied by the average participation likelihood and site participation weighting factor multiplied by the site participation likelihood.

As stated above, the algorithm module 202 may base the participation likelihood of a site 104 on data related to the site 104. The data may be generated at one or more of the sites 104, the utility 106, the DR aggregator 108, or one or more data sources 210. The data may then be communicated throughout the DR system 100 via a network that communicatively couples the sites 104, the utility 106, and the DR aggregator 108. Additionally or alternatively, the data may be used locally in the algorithm module 202.

The data sources 210 may include any entity that acquires and/or makes available data that may be relevant to participation likelihood and/or demand flexibility as calculated by the algorithm module 202. For example, the data sources 210 may include a meteorology organization. The meteorology organization may communicate ambient condition data (described below) to the algorithm module 202. Some examples of the data are described with reference to FIG. 3.

FIG. 3 illustrates a block diagram 300 of an example system 340 that may be implemented in the DR system 100 of FIGS. 1 and 2, arranged in accordance with at least one embodiment described herein. The system 340 may represent one or more of the utility 106, the DR aggregator 108, and/or one or more of the sites 104 of FIGS. 1 and 2.

As illustrated, the system 340 may also include a processor 342, a communication interface 346, and a memory 344. The processor 342, the communication interface 346, and the memory 344 may be communicatively coupled via a communication bus 348. The communication bus 348 may include, but is not limited to, a memory bus, a storage interface bus, a bus/interface controller, an interface bus, or the like or any combination thereof.

In general, the communication interface 346 may facilitate communications over a network. The communication interface 346 may include, but is not limited to, a network interface card, a network adapter, a LAN adapter, or other suitable communication interface. The data 326 may be communicated to the system 340 via the communication interface, for instance.

The processor 342 may be configured to execute computer instructions that cause the system 340 to perform the functions and operations described herein. The processor 342 may include, but is not limited to, a processor, a microprocessor (μP), a controller, a microcontroller (μC), a central processing unit (CPU), a digital signal processor (DSP), any combination thereof, or other suitable processor.

Computer instructions may be loaded into the memory 344 for execution by the processor 342. For example, the computer instructions may be in the form of one or more modules (e.g., modules 302, 304, 306, 308, 310, 312, 314, 316, 318, 320, 322, and 324). In some embodiments, data generated, received, and/or operated on during performance of the functions and operations described herein may be at least temporarily stored in the memory 344. Moreover, the memory 344 may include volatile storage such as RAM. More generally, the system 340 may include a non-transitory computer-readable medium such as, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer-readable medium.

The example system 340 depicted in FIG. 3 includes an example embodiment of the algorithm module 202 and is receiving data 326. Based on the data 326 received by the system 340, the algorithm module 202 may estimate participation likelihood and/or demand flexibility of a site, such as one of the sites 104 of FIGS. 1 and 2.

The data 326 may include the data as described with reference to FIG. 2 as well as the data 326 depicted in FIG. 3. For example, the data 326 may include, but is not limited to, productivity information 328, DR event information 330, ambient condition data 332, load data 334, local generation data 336, and occupancy data 338. The productivity information 328 may be information related to the effect that resource usage curtailment imposes on productivity of a site. The DR event information 330 may include information pertaining to an upcoming DR event such as incentive information, a time period of the DR event, and minimum DR event requirement. Additionally, the DR event information 330 may include whether or not a site participated in one or more past DR events and information pertaining to the one or more past DR events. The ambient condition data 332 may include temperatures, wind conditions, cloud cover, time, precipitation, or any other data that may be used by the algorithm module 202. The load data 334 may include the resource usage during one or more predefined time periods. The load data 334 may be specific to a site such as one of the sites 104 of FIGS. 1 and 2. The local generation data 336 may include the resource locally generated or available at a site and/or resources provided by another utility. The local generation data 336 may result from solar cells, wind turbines, or any other local resource generation system. The occupancy data 338 may include a capacity at which a site is operating. For example, the occupancy data 338 may include a number of employees scheduled to work or currently working, a number of animals scheduled to be indoors or currently indoors, or the like.

The algorithm module 202 may include a flexibility/participation estimation module 324 (In FIG. 3, “estimation module 324”). The flexibility/participation estimation module 324 may include multiple modules that may receive a portion of the data 326 and perform an operation included in an estimation algorithm. The modules may be in communication with one another. For example, a result generated in one of the modules may be communicated to one or more other modules. Likewise a result may be stored in one or more of the modules and later loaded for an additional operation.

The modules shown in the flexibility/participation estimation module 324 are not meant to be limiting. For instance, an operation performed in the flexibility/participation estimation module 324 may include a subset of the modules. Moreover, in some embodiments, the flexibility/participation estimation module 324 may include additional modules that perform other operations.

In some embodiments, the flexibility/participation estimation module 324 may perform analysis of the data 326. Based on the analysis of the data 326, the flexibility/participation estimation module 324, and in particular, a parameter quantifying module 302, may quantify one or more resource usage parameters (hereinafter, “parameters”) that may be used by an estimation module 324. The parameters may relate to resource usage of a specific site, resource usage of a group of sites, an ambient condition, or some combination thereof.

In these and other embodiments, the parameters may be quantified based on one or more of historical load information, a load/ambient condition relationship, expected load information, actual load information, or some combination thereof. To calculate the historical load information, the parameter quantifying module 302 may include a historical load module 304. To calculate the load/ambient condition relationship, the parameter quantifying module 302 may include a load/ambient condition relationship module 308. To calculate the expected load information, the parameter quantifying module 302 may include an expected load module 306. To calculate the actual load information, the parameter quantifying module 302 may include an actual load module 310. The parameter quantifying module 302 may then access one or more of the historical load information, the load/ambient condition relationship, the expected load information, and the actual load information and quantify one or more parameters therefrom.

Each of the historical load module 304, the expected load module 306, the load/ambient condition relationship module 308, and the actual load module 310 may receive some portion of the data 326 and perform one or more operations thereon. The operations may be selected to analyze the data 326 such that the parameters may be based upon the data 326. The operations performed by any of the historical load module 304, the expected load module 306, the load/ambient condition relationship module 308, and the actual load module 310 may include, but are not limited to, time-averaging a subset of the data 326, finding a maximum and/or minimum value of a subset of the data 326, finding a relationship between subsets of the data 326, forecasting future information based on past information, setting granularities for subsets of the data 326, and finding a mean square error (MSE) of a subset of the data 326.

For example, in some embodiments, the historical load module 304 may receive the load data 334, the local generation data 336, and/or the occupancy data 338 for a site over a first defined time period. The first defined time period may include energy usage data that may be representative of a time period of a DR event, for instance. The first defined time period may be multiple days in some embodiments. The historical load module 304 may then perform one or more operations on the load data 334, the local generation data 336, and/or the occupancy data 338. In these and other embodiments, the historical load module 304 may calculate historical load information including a variability of peak load at peak times. The variability of peak load at peak times may be represented by the variable Vₚₑₐₖ. The historical load information may be calculated or otherwise determined at one or more discrete times.

Additionally, the expected load module 306 may receive the load data 334, the local generation data 336, and/or the occupancy data 338 for the site over the first predefined period. The expected load module 306 may perform one or more operations on the load data 334, the local generation data 336, and/or the occupancy data 338 for the first predefined period to calculate expected load information. The expected load information may include an expected resource load during a day of a DR event, an expected local resource generation during a day of a DR event, an expected occupancy during a day of a DR event, or any combination thereof. The expected resource load during a day of a DR event may be represented by a variable Lₚ. The expected local resource generation during the day of the DR event may be represented by a variable Gₚ. The expected occupancy during the day of the DR event may be represented by a variable Oₚ. The expected load information may be calculated or otherwise determined at one or more discrete times.

Additionally, the actual load module 310 may receive load data 334, the local generation data 336, and/or the occupancy data 338 for the site over a second predefined period. The second predefined time period may be minutes or hours before a DR event, for example. The actual load module 310 may perform one or more operations on the load data 334, the local generation data 336, and/or the occupancy data 338 for the second predefined period to calculate actual load information. The actual load information may include an actual resource load, an actual local resource generation, an actual occupancy, or any combination thereof. The actual resource load may be represented by a variable L_{today}. The actual local resource generation may be represented by a variable G_{today}. The actual occupancy may be represented by a variable O_{today}. The actual load information may be calculated or otherwise determined at one or more discrete times.

The load/ambient condition relationship module 308 may receive the ambient condition data 332 for the first predefined time period (i.e., past ambient condition data) and the ambient condition data 332 for the second predefined time period (i.e., actual ambient condition data). The load/ambient condition relationship module 308 may perform one or more operations using the ambient condition data 332 and any of the historical load information, the expected load information, and the actual load information to find relationships between resource usage of the site and one or more ambient conditions. For example, the load/ambient condition relationship module 308 may calculate a correlation between peak load and temperature, a correlation between daily load and temperature, a relationship between actual resource load and temperature, or any combination thereof. The correlation between peak load and temperature may be represented by a variable TCₚₑₐₖ. The correlation between daily load and temperature may be represented by a variable TC_{daily}. The relationship between actual resource load and temperature may be represented by a variable TC_{today}. The load/ambient condition relationships may be calculated or otherwise determined at one or more discrete times.

In some embodiments, the data 326 from the first predefined time period and/or the second predefined time period may include a single granularity. For example, the granularity may be about 15 minutes. The granularity may be adjustable in some circumstances, which may enable the data 326 to more precisely represent conditions of a site and may also increase processing overhead. The granularity may also be adjusted to reduce processing overhead, which may less-precisely represent conditions of the site.

As stated above, after the historical load information, the load/ambient condition relationship, the expected load information, and the actual load information are calculated; the parameter quantifying module 302 may quantify one or more parameters based thereon. In some circumstances, one or more of the parameters may be equivalent to one or more of the historical load information, the load/ambient condition relationship, the expected load information, or the actual load information. Alternatively, one or more of the parameters may be based on the historical load information, the load/ambient condition relationship, the expected load information, or the actual load information. For instance, the parameter quantifying module 302 may perform one or more operations on the historical load information, the load/ambient condition relationship, the expected load information, and/or the actual load information.

In these and other embodiments, the parameters may include variability of peak load at peak times “Vₚₑₐₖ,” the correlation between peak load and temperature “TCₚₑₐₖ” a load error “Lₑᵣᵣₒᵣ,” a peak load versus temperature error “TCₑᵣᵣₒᵣ,” a local generation error “Gₑᵣᵣₒᵣ,” an occupancy error “Oₑᵣᵣₒᵣ,” and an error parameter.

The load error may be calculated in some embodiments by an example load error equation:

Lₑᵣᵣₒᵣ=MSE((Lₚ(tᵢ . . . tⱼ),L_{today}(tᵢ . . . tⱼ)))

In the load error equation, Lₑᵣᵣₒᵣ represents the load error. The operator, MSE, represents the mean square error. The variable Lₚ represents the expected resource load. The variable L_{today} represents the actual resource load. The variables tᵢ . . . tⱼ represent discrete times at which the expected resource load and the actual resource load are calculated or otherwise determined.

The peak load versus temperature error may be calculated in some embodiments by an example peak load versus temperature error equation:

TCₑᵣᵣₒᵣ MSE(|TC_{daily}(tᵢ . . . tⱼ),TC_{today}(tᵢ . . . tⱼ)|)

In the peak load versus temperature error equation, TCₑᵣᵣₒᵣ represents the peak load versus temperature error. The operator, MSE, represents the mean square error. The variable TC_{daily}, represents the correlation between daily load and temperature. The variable TC_{today} represents relationship between actual resource load and temperature. The variables tᵢ . . . tⱼ represent discrete times at which the correlation between daily load and temperature and the relationship between actual resource load and temperature are calculated or otherwise determined.

The local generation error may be calculated in some embodiments by an example local generation error equation:

Gₑᵣᵣₒᵣ=MSE(|Gₚ(tᵢ . . . tⱼ),G_{today}(tᵢ . . . tⱼ)|)

In the local generation error equation, Gₑᵣᵣₒᵣ represents the local generation error. The operator, MSE, represents the mean square error. The variable Gₚ represents expected local resource generation during the day of the DR event. The variable G_{today} represents the actual local resource generation. The variables tᵢ . . . tⱼ represent discrete times at which the expected local resource generation and the actual local resource generation are calculated or otherwise determined.

The occupancy error may be calculated in some embodiments by an example occupancy error equation:

Oₑᵣᵣₒᵣ=MSE(|Oₚ(tᵢ . . . tⱼ),O_{today}(tᵢ . . . tⱼ)|)

In the occupancy error equation, Oₑᵣᵣₒᵣ represents the occupancy error. The operator, MSE, represents the mean square error. The variable Oₚ represents the expected occupancy during the day of the DR event. The variable O_{today} represents the actual occupancy. The variables tᵢ . . . tⱼ represent discrete times at which the expected occupancy and the actual occupancy are calculated or otherwise determined.

The participation estimation module 324 may also include a DR event module 312, a coefficient determination module 314, a weighting factor determination module 316, a comparison module 318, an arithmetic module 320, and an adjusting module 322 (collectively, non-parameter modules). To estimate demand flexibility and/or participation likelihood of a site, the non-parameter modules may perform one or more operations based on the parameters and/or the data 326.

Specifically, the comparison module 318 and the arithmetic module 320 may be used to estimate a participation likelihood and/or a demand flexibility of a site. In these and other embodiments, the demand flexibility and/or the participation likelihood may be estimated based at least partially on a summation of products of coefficients, which are based upon the parameters, multiplied by weighting factors assigned to each of the weighting factors. In some embodiments the estimations may be based upon an example estimation equation:

DF=(ω₁xα+ω₂xβ+ω₃xγ+ω₄xδ+ω₅xθ+ω₆xλ+ω₇xμ+ω₈xφ)

In the estimation equation, DF represents an estimated demand flexibility or an indication thereof. The variables α, β, γ, δ, θ, λ, μ, and φ represent the coefficients. The variables ω₁, ω₂, ω₃, ω₄, ω₅, ω₆, ω₇, and ω₈ represent the weighting factors assigned to the coefficients.

The coefficient determination module 314 may determine a value for each of the coefficients. Generally, the coefficients may be mathematical constants (i.e., non-variables) based on the parameters. In some embodiments, the values of the coefficients may be based on a comparison between a parameter and a significance threshold. The significance threshold may be a value deemed determinative for the parameter relative to a site or group of sites. In some embodiments, a coefficient may be determined by an example coefficient determination equation:

if: P>X

then: adjust_coefficien t

In the coefficient determination equation, P represents the parameter. The variable X represents the significance threshold. The operator, “adjust_coefficient” represents an adjustment to the coefficient based on the parameter P.

In these and other embodiments P may include any of the parameters defined above. Specifically, P may include the variability of peak load at peak times “Vₚₑₐₖ,” the correlation between peak load and temperature “TCₚₑₐₖ,” the load error “Lₑᵣᵣₒᵣ,” the peak load versus temperature error “TCₑᵣᵣₒᵣ,” the local generation error “Gₑᵣᵣₒᵣ,” the occupancy error “Oₑᵣᵣₒᵣ,” and the error parameter. Each of the parameters may have a significance threshold (X), which may be independent of the significance thresholds for some or all of the other parameters.

For example, the coefficient α may be based on the variability of peak load at peak times Vₚₑₐₖ. A significance threshold for the variability of peak load at peak times Vₚₑₐₖ may be 10 kiloWatts (kW) in a DR system supplying electricity. When the variability of peak load at peak times Vₚₑₐₖ is i greater than 10 kW, the value of the coefficient may be adjusted or determined.

The initial values of the significance thresholds and/or the coefficients may be determined through analysis of other sites that may be similar to the site at issue, may be determined through trial and error, and/or may be adjusted by the adjusting module 322 based on site behavior and machine learning as described below.

In these and other embodiments, the comparison module 318 may determine a relationship between the parameters and the significance thresholds. Based on the relationship between the parameters and the significance thresholds, the coefficients may be determined and/or adjusted. In some embodiments, one coefficient may be determined for each of the parameters. Additionally or alternatively, one coefficient may be determined for multiple parameters.

The weighting factor determination module 316 may assign the weighting factors to the coefficients. The weighting factors may be fractions, decimals, or percentages that reflect the relative importance of the coefficient to which the weighting factor is assigned. In some embodiments the sum of ω₁, ω₂, ω₃, ω₄, ω₅, ω₆, ω₇, and ω₈ may be equal to 1. Accordingly, increasing the weighting factor associated with one coefficient may reduce the weighting factor associated with at least one other coefficient.

Like the significance thresholds and the coefficients, the weighting factors may be initially determined through analysis of other sites that may be similar to the site at issue, may be determined through trial and error, and may be adjusted by the adjusting module 322 based on site behavior and/or machine learning as described below.

Additionally, in some embodiments, the arithmetic module 320 may estimate the participation likelihood based on the demand flexibility or indication thereof (DF) and historical behavior of the site. For example, the arithmetic module 320 may estimate the participation likelihood of a site based on a participation likelihood estimation equation:

DR=(W₁xC)+(W₂x(DF))

In the participation likelihood estimation equation, DR represents the estimated participation likelihood. The variable W₁ represents a past weighting factor. The variable C represents the fraction of past DR events in which the site participated (hereinafter, “fraction”). The variable W₂ represents a forecast weighting factor. The variable DF represents the demand flexibility or an indication thereof.

The weighting factor determination module 316 may assign the past weighting factor (W₁) and the forecast weighting factor (W₂) to the fraction (C) and the demand flexibility (DF), respectively. The past weighting factor (W₁) and the forecast weighting factor (W₂) may be selected by a managing entity, through analysis of other sites that may be similar to the site at issue, may be determined through trial and error, and/or may be adjusted by the adjusting module 322 based on site behavior and machine learning as described below.

The past weighting factor (W) and the forecast weighting factor (W₂) may be fractions, decimals, or percentages that reflect the relative importance of the fraction (C) and the demand flexibility or indication thereof. In some embodiments the sum of the past weighting factor (W₁) and (W₂) may be equal to 1. Accordingly, increasing the forecast weighting factor (W₂) may reduce the past weighting factor (W₁).

According to the participation likelihood estimation equation, estimating the participation likelihood may include multiplying each of the coefficients by a weighting factor associated with each of the coefficients. The products of the coefficients and the associated weighting factors are summed. The forecast weighting factor is multiplied by the summation of the products of the coefficients and the associated weighting factors. The past weighting factor is multiplied by the fraction of past DR events. The estimated participation likelihood may be the sum of the products of the forecast weighting factor multiplied by the summation of the products of the coefficients and the associated weighting factors and the products of the past weighting factor multiplied by the fraction of past DR events.

The DR event module 312 may be configured to receive the DR event information 330, which may include information related to an upcoming DR event and/or past DR events. The portion of the DR event information 330 related to the DR event may include incentive information of a DR event and/or a DR participation requirement, for instance. The incentive information may include an incentive such as a financial or resource credit provided by a utility (e.g., the utility 106 of FIG. 1) for compliance with a DR event. Additionally, the incentive information may include penalties (e.g., financial penalties) that may be incurred by a site for noncompliance. The DR participation requirement may include a specific resource usage curtailment over a specified time period. For example, a DR participation requirement may include a 10 kilowatt reduction between 2:00 PM and 5:00 PM.

Additionally, the DR event module 312 may calculate one or more other values related to a DR event. In some embodiments, the DR event module 312 may also receive the productivity information 328. From the DR event information 330 and/or the productivity information 328, the DR event module 312 may calculate a fraction of past DR events in which a site participated, a productivity metric for a DR event day on which the DR event is to occur, and a maximum DR level. The fraction of past DR events may be calculated as a fraction or a percentage. The productivity metric may include a determination of the financial or productivity losses that may result due to an energy usage curtailment included in a DR event. For example, increasing a temperature inside a factory during a work day may result in productivity losses totaling $25,000. The maximum DR level may generally relate to the energy usage curtailment that is pragmatic as a function of the productivity metric and/or the incentive information.

In some embodiments, the productivity metric for the DR event day may be externally calculated and communicated to the DR event module 312. In these and other embodiments, the productivity information 328 may include the productivity metric and/or the information related to the effect that resource usage curtailment imposes on productivity of a site.

Additionally or alternatively, in some embodiments, the comparison module 318 may determine whether the maximum DR level is less than the minimum DR participation requirement. When the maximum DR level is less than the minimum DR participation requirement, the participation likelihood and/or the demand flexibility may be zero.

Additionally or alternatively, the comparison module 318 may determine whether an incentive in the incentive information is less than the productivity metric. When the incentive is less than the productivity metric, the participation likelihood and/or the demand flexibility may be zero.

The non-parameter modules may also include the adjusting module 322. The adjusting module 322 may adjust one or more of the weighting factors, the coefficients, and the significance thresholds of a site. The adjustments may be based on parameters, the changes thereto, behaviors of a site (i.e., participation and non-participation in a DR event), and relationships between behaviors of the site and changes to parameters. Through adjusting the weighting factors, the coefficients, and the significance thresholds of a site, optimal values for each of the weighting factors, the coefficients, and the significance thresholds of a site may be found.

For example, in a first DR event a first coefficient may be set to a first value (e.g., α=5). A first weighting factor may be assigned to the first coefficient (e.g., ω₁=0.2). The estimated participation likelihood for the site in the first DR event may be 80%. However, the site does not participate in the first DR event. In a second DR event, the first coefficient may change to a second value (e.g., α=6), but the other coefficients and the first weighting factor may remain the same. The estimated participation likelihood for the site in the second DR event may be 75%. The site may participate in the second DR event. The adjusting module 322 may recognize that the first coefficient has been improperly weighed and/or the significance threshold is inappropriately set. The adjusting module 322 may accordingly adjust the weighting factor associated with the first coefficient (e.g., ω₁=0.25) and/or the significance threshold. In some embodiments, when the first weighting factor is increased, the weighting factors for the other coefficients may be correspondingly reduced. When a third DR event is scheduled, the estimated participation likelihood for the site may be more accurately predicted.

In some embodiments, the adjusting module may include machine learning techniques. Adjustments to one or more of the weighting factors, the coefficients, and the significance thresholds may be adjusted using these machine learning techniques. An example machine learning technique may include neural networks or another suitable machine learning technique.

Additionally, in some embodiments, the adjusting module 322 may include a rate of learning. The rate of learning may include an interval at which the adjustment module 322 performs adjustments. The rate of learning may be variable. For example, to increase a rate at which adjustments are made, the rate of learning may be increased.

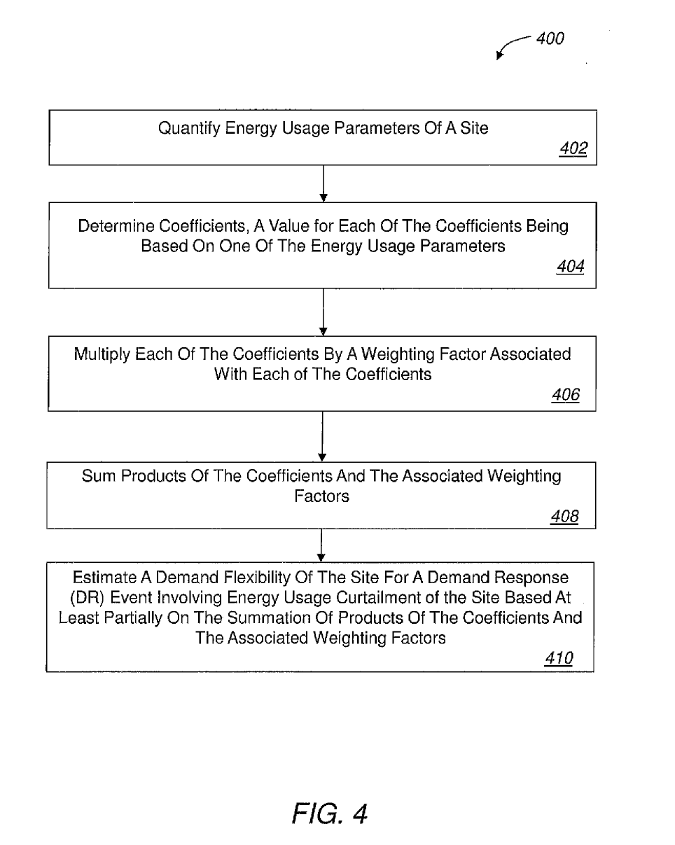

FIG. 4 is a flow diagram of an example method estimating demand flexibility of a site, arranged in accordance with at least one embodiment described herein. The method 400 may be performed in a DR system such as DR system 100 of FIGS. 1 and 2 in which the utility 106 provides electricity to the sites 104. It may be appreciated with the benefit of this disclosure that similar methods may be implemented to estimate demand flexibility in DR systems in which the utility 106 provides any other suitable resource to the sites 104.

The method 400 may be programmably performed in some embodiments by the system 340 described with reference to FIG. 3 and/or one or more of the utility 106, the DR aggregator 108, and the sites 104 of FIGS. 1 and 2. In some embodiments, the system 340 may include or may be communicatively coupled to a non-transitory computer-readable medium (e.g., the memory 344 of FIG. 3) having stored thereon programming code or instructions that are executable by a computing device to cause the computing device to perform the method 400. Additionally or alternatively, the system 340 may include the processor 342 described above that is configured to execute computer instructions to cause a computing system to perform the method 400. Although illustrated as discrete blocks, various blocks may be divided into additional blocks, combined into fewer blocks, or eliminated, depending on the desired implementation.

At block 402, energy usage parameters of a site may be quantified. In some embodiments, the parameters may be based on one or more of historical load information, a load/ambient condition relationship, an expected load actual site load, an error parameter, any combination thereof, or other suitable information.

The historical load information may be calculated using load data acquired during a first predefined time period. In some embodiments, the first predefined time period may be prior to a DR event day. The historical load information may include a variability of a peak load, for instance. The load/ambient condition relationship may be based on past ambient condition data and the load data. In some embodiments, the past ambient condition data and the load data may be acquired during the first predefined time period. The load/ambient condition relationship may additionally or alternatively be based on ambient condition data and load data acquired during a second predefined time period. The load/ambient condition relationship may be a correlation between the historical site load information and an ambient condition, for example. The expected load for the site may include a load forecasted for the DR event day. The actual load may be based on load data acquired during a second predefined time period. In some embodiments, the second predefined time period may minutes or hours prior to the DR event.

At block 404, coefficients may be determined. A value for each of the coefficients may be based on one of the parameters. In some embodiments, determining the coefficients may include comparing one of the parameters to a significance threshold for the parameter to determine whether the parameter is greater than the significance threshold. When the parameter is greater than the significance threshold, the value of the coefficient may be adjusted.

At block 406, each of the coefficients may be multiplied by a weighting factor associated with each of the coefficients. At block 408, the products of the coefficients and the associated weighting factors may be summed. At block 410, a demand flexibility of the site for a DR event involving energy usage curtailment may be estimated. The demand flexibility may be based at least partially on the summation of the products of the coefficients and the associated weighting factors.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

For instance, the method 400 may include calculating a fraction of past DR events in which the site participated (hereinafter, “fraction”) and assigning a past weighting factor to the fraction. Additionally, the method 400 may include assigning a forecast weighting factor to a summation of the products of the coefficients and the associated weighting factors (hereinafter, “summation”). In some embodiments, the past weighting factor may be multiplied by the fraction, and the forecast weighting factor may be multiplied by the summation. Products of the past weighting factors multiplied by the fraction and the forecast weighting factors multiplied by the summation may be further summed. A participation likelihood of the site may be estimated based on the products of the past weighting factor multiplied by the fraction and the forecast weighting factor multiplied by the summation.

Additionally or alternatively, the method 400 may include adjusting one or more of the weighting factors associated with one or more of the coefficients, adjusting one or more of the coefficients; adjusting one of the significance threshold for one or more of the parameters, or any combination thereof.

Additionally or alternatively, the method 400 may include computing and/or receiving a productivity metric for a DR event day on which the DR event is to occur and obtaining incentive information for the DR event. The productivity metric may be compared to an incentive included in the incentive information. When the incentive is less than the productivity metric, the demand flexibility may be determined to be zero.

Additionally or alternatively, the method 400 may include obtaining a minimum DR participation requirement for the DR event. A maximum DR level may be calculated based on the productivity metric and the incentive information. The maximum DR level may be compared to the minimum DR participation requirement. When the maximum DR level is less than the minimum DR participation requirement, the demand flexibility may be determined to be zero.

Additionally or alternatively, the method 400 may include estimating a participation likelihood based on the demand flexibility. Based on the participation likelihood, the method 400 may include identifying that the site is a potential DR customer.

Additionally or alternatively, the method 400 may include estimating a participation likelihood based on the demand flexibility. Based on the participation likelihood, the method 400 may include predicting participation of the site in the DR event.

In some embodiments, predicting participation of the site may include calculating an average participation likelihood for the DR event for multiple sites including the site. The average participation likelihood may be based on estimated demand flexibilities of the sites. In addition, in these and other embodiments, the method 400 may include assigning a group participation weighting factor to the average participation likelihood and assigning a site participation weighting factor to the site participation likelihood. In some embodiments, the group participation weighting factor may be multiplied by the average participation likelihood and the site participation weighting factor may be multiplied by the participation likelihood. The products of the group participation weighting factor multiplied by the average participation likelihood and site participation weighting factor multiplied by the participation likelihood may be summed. A refined participation likelihood of the site for the DR event may be estimated based on the summation of the products of the group participation weighting factor multiplied by the average participation likelihood and participation weighting factor multiplied by the participation likelihood.

Additionally or alternatively, the method 400 may include determining whether to participate in a DR event based on the demand flexibility. For example, a site manager may determine that the site should participate in the DR event based on the demand flexibility.

The embodiments described herein may include the use of a special purpose or general purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include tangible computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modules running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present invention have been described in detail, it should be understood that the various changes, substitutions, and alterations could be made hereto without departing from the spirit and scope of the invention.

What is claimed is:

1. A method comprising:
quantifying energy usage parameters of a site;
determining coefficients, a value for each of the coefficients being based on one of the energy usage parameters;
multiplying each of the coefficients by a weighting factor associated with each of the coefficients;
summing products of the coefficients and the associated weighting factors; and
estimating a demand flexibility of the site for a demand response (DR) event involving energy usage curtailment based at least partially on the summation of the products of the coefficients and the associated weighting factors.

2. The method of claim 1, further comprising:
calculating a fraction of past DR events in which the site participated;
assigning a past weighting factor to the fraction;
assigning a forecast weighting factor to the summation of the products of the coefficients and the associated weighting factors;
multiplying the past weighting factor by the fraction and the forecast weighting factor by the summation of the products of the coefficients and the associated weighting factors; and
further estimating a participation likelihood based on a second summation of products of the past weighting factor multiplied by the fraction and the forecast weighting factor multiplied by the summation of the products of the coefficients and the associated weighting factors.

3. The method of claim 1, further comprising adjusting one or more of:
one or more of the weighting factors associated with one or more of the coefficients;
one or more of the coefficients; and
a significance threshold for one or more of the energy usage parameters.

4. The method of claim 1, further comprising:
obtaining incentive information for a DR event;
determining whether an incentive included in the incentive information is less than a productivity metric for a DR event day on which the DR event is to occur; and
when the incentive is less than the productivity metric, determining the participation likelihood to be zero.

5. The method of claim 4, further comprising:
obtaining a minimum DR participation requirement for the DR event;
calculating a maximum DR level based on the productivity metric and the incentive information;
determining whether the maximum DR level is less than the minimum DR participation requirement; and
when the maximum DR level is less than the minimum DR participation requirement, determining the demand flexibility to be zero.

6. The method of claim 1, wherein the energy usage parameters are based on one or more of:
historical load information based on load data acquired during a first predefined time period;
a load/ambient condition relationship based on ambient condition data acquired during the first predefined time period and the load data acquired during the first predefined time period;
a load/ambient condition relationship based on ambient condition data acquired during a second predefined time period and load data acquired during the second predefined time period; expected load information for the site on the DR event day; and
actual load information based on load data acquired during the second predefined time period.

7. The method of claim 1, wherein the determining coefficients includes:
determining whether the one of the energy usage parameters is greater than a significance threshold for the energy usage parameter; and
when the energy usage parameter is greater than the significance threshold for the energy usage parameters, adjusting the coefficient based on the energy usage parameter.

8. The method of claim 1, further comprising:
further estimating a participation likelihood for the site based on the demand flexibility; and
identifying that the site is a potential DR customer based on the participation likelihood.

9. The method of claim 1, further comprising:
further estimating a participation likelihood for the site based on the demand flexibility; and
predicting participation of the site in the DR event based on the participation likelihood.

10. The method of claim 9, wherein the predicting includes:
calculating an average participation likelihood for the DR event for sites grouped together based on a common characteristic, the average participation likelihood based on estimated demand flexibilities of the sites;
assigning a group participation weighting factor to the average participation likelihood;
assigning a site participation weighting factor to the participation likelihood;
summing products of the group participation weighting factor multiplied by the average participation likelihood and site participation weighting factor multiplied by the participation likelihood; and
calculating a refined participation likelihood of the site for the DR event based on the summation of the products of the group participation weighting factor multiplied by the average participation likelihood and site participation weighting factor multiplied by the participation likelihood.

11. The method of claim 1, further comprising determining whether to participate in a DR event based on the demand flexibility.

12. A non-transitory computer-readable medium having encoded therein programming code executable by a processor to perform operations comprising:
quantifying energy usage parameters of a site;
determining coefficients, a value for each of the coefficients being based on one of the energy usage parameters;
multiplying each of the coefficients by a weighting factor associated with each of the coefficients;
summing products of the coefficients and the associated weighting factors; and
estimating a demand flexibility of the site for a demand response (DR) event involving energy usage curtailment based at least partially on the summation of the products of the coefficients and the associated weighting factors.

13. The non-transitory computer-readable medium of claim 12, wherein the operations further comprise:
calculating a fraction of past DR events in which the site participated;
assigning a past weighting factor to the fraction;
assigning a forecast weighting factor to the summation of the products of the coefficients and the associated weighting factors;
multiplying the past weighting factor by the fraction and the forecast weighting factor by the summation of the products of the coefficients and the associated weighting factors; and
further estimating a participation likelihood based on a second summation of products of the past weighting factor multiplied by the fraction and the forecast weighting factor multiplied by the summation of the products of the coefficients and the associated weighting factors.

14. The non-transitory computer-readable medium of claim 12, wherein the operations further comprise adjusting one or more of:
one or more of the weighting factors associated with one or more of the coefficients;
one or more of the coefficients; and
a significance threshold for one or more of the energy usage parameters.

15. The non-transitory computer-readable medium of claim 12, wherein the operations further comprise:
receiving a productivity metric for a DR event day on which the DR event is to occur;
obtaining incentive information for the DR event and a minimum DR participation requirement for the DR event;
calculating a maximum DR level based the productivity metric and the incentive information;
determining whether the productivity metric is greater than an incentive included in the incentive information and whether the maximum DR level is less than the minimum DR participation requirement; and
determining the demand flexibility to be zero when the maximum DR level is less than the minimum DR participation requirement or when the productivity metric is greater than the incentive.

16. The non-transitory computer-readable medium of claim 12, wherein the energy usage parameters are based on one or more of:
historical load information based on load data acquired during a first predefined time period;
a load/ambient condition relationship based on ambient condition data acquired during the first predefined time period and the load data acquired during the first predefined time period;
a load/ambient condition relationship based on ambient condition data acquired during a second predefined time period and load data acquired during the second predefined time period;
expected load information for the site on the DR event day; and
actual load information based on load data acquired during the second predefined time period.

17. The non-transitory computer-readable medium of claim 12, wherein the operations further comprise:
further estimating a participation likelihood for the site based on the demand flexibility; and
identifying that the site is a potential DR customer based on the participation likelihood.

18. The non-transitory computer-readable medium of claim 12, wherein the operations further comprise:
further estimating a participation likelihood for the site based on the demand flexibility; and
predicting participation of the site in the DR event based on the participation likelihood.

19. The non-transitory computer-readable medium of claim 18, wherein the predicting includes:
calculating an average participation likelihood for the DR event for sites grouped together based on a common characteristic, the average participation likelihood based on estimated demand flexibilities of the sites;
assigning a group participation weighting factor to the average participation likelihood;
assigning a site participation weighting factor to the participation likelihood;
summing products of the group participation weighting factor multiplied by the average participation likelihood and site participation weighting factor multiplied by the site participation likelihood; and
calculating a refined participation likelihood of the site for the DR event based on the summation of the products of the group participation weighting factor multiplied by the average participation likelihood and site participation weighting factor multiplied by the participation likelihood.

20. The non-transitory computer-readable medium of claim 12, wherein the operations further comprise determining whether to participate in a DR event based on the demand flexibility.
